(19) United States
(12) Patent Application Publication
(10) Pub. No.: US 2016/0028724 A1
(43) Pub. Date: Jan. 28, 2016

(54) Identity Reputation

(71) Applicant: Microsoft Corporation, Redmond, WA (US)

(72) Inventor: Mark Alastair Gillett, London (GB)

(21) Appl. No.: 14/444,967

(22) Filed: Jul. 28, 2014

(51) Int. Cl. H04L 29/06; G06Q 20/40

(52) U.S. Cl. CPC H04L 63/0861; G06Q 20/40145

(57) ABSTRACT

A method of indicating a reputation of a first user associated with a first user device to a second user associated with a second user device, the method comprising: detecting at the first user device initiation by the first user of a communication event to the second user; in response to said detection, capturing one or more characteristics of said first user at the first user device; and transmitting a request to establish a communication event to the second user, the transmitted request including an indication of an asserted identity of the first user and information relating to the captured one or more characteristics of said first user such that the second user can make an assessment as to the likelihood that the first user is validly correlated with the asserted identity.

### RELATED APPLICATIONS

This application claims priority under 35 USC §119 or §365 to Great Britain Patent Application No. 1400826.2 entitled “IDENTITY REPUTATION” filed Jan. 17, 2014, the disclosure of which is incorporate in its entirety.

### BACKGROUND

Financial Institutions, Utilities, and Government institutions, often have the need to interact with people (typically consumers) over a public communications network, typically the Public Switched Telephone Network (PSTN).

Simultaneously, these institutions are desirous of transacting (i) authenticated and/or (ii) non repudiable transactions with people (e.g. a bank transfer, account enquiry, billing change or other transaction requiring either disclosure of confidential (often legally controlled, regulated or similar) information or action which requires authorization from the ‘known’ party in the communication.

Today for example banks use various means to identify, authenticate and authorize transactions when engaging over these public networks, including Personal Identification Numbers (PINs), passwords, secure tokens, known information etc.

These mechanisms introduce either inconvenience, overhead and/or potential failures for the user of the service, while simultaneously not necessarily being as secure as the institution might like.

### SUMMARY

The inventor has realised that communications, particularly voice and video communications provide for the opportunity for a service to adjudicate on the probability that a calling party is validly correlated with the identity that the calling party asserts.

According to one aspect of the present disclosure there is provided a method of indicating a reputation of a first user associated with a first user device to a second user associated with a second user device, the method comprising: detecting at the first user device initiation by the first user of a communication event to the second user; in response to said detection, capturing one or more characteristics of said first user at the first user device; and transmitting a request to establish a communication event to the second user, the transmitted request including an indication of an asserted identity of the first user and information relating to the captured one or more characteristics of said first user such that the second user can make an assessment as to the likelihood that the first user is validly correlated with the asserted identity.

In one embodiment, a communication client executed on the first user device performs the above method steps, wherein the communication client transmits the request to establish a communication event to the second user device over a communications network, the transmitted request comprising the captured one or more characteristics of the first user.

In another embodiment, a communication client executed on the first user device performs the detecting and capturing steps, the communication client transmitting the indication of an asserted identity of the first user and the information relating to the captured one or more characteristics of the first user to an adjudicating module, wherein the method further comprising the adjudicating module estimating the likelihood that the first user is validly correlated with the asserted identity and transmitting the request to establish a communication event to the second user, the transmitted request comprising an indication of the estimated likelihood.

The adjudicating module may be implemented on the first user device, the second user device or on a network entity of said communications network.

According to one aspect of the present disclosure there is provided a computer program product, the computer program product being embodied on a non-transient computer-readable medium and configured so as when executed on processor means to perform the methods described herein performed by the adjudicating module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present disclosure and to show how the same may be put into effect, reference will now be made, by way of example, to the following drawings in which:

FIG. 1 shows a communication system;

FIG. 2 shows a schematic view of a user terminal;

FIG. 3 is a flow chart for a process of establishing characteristics of users of the communication system for use in an adjudicating process;

FIG. 4 is a flow chart for an adjudicating process;

FIG. 5 is a flow chart for a communication event establishment process; and

FIG. 6 is a flow chart for a non-repudiation process.

### DETAILED DESCRIPTION

Embodiments of the present disclosure will now be described by way of example only.

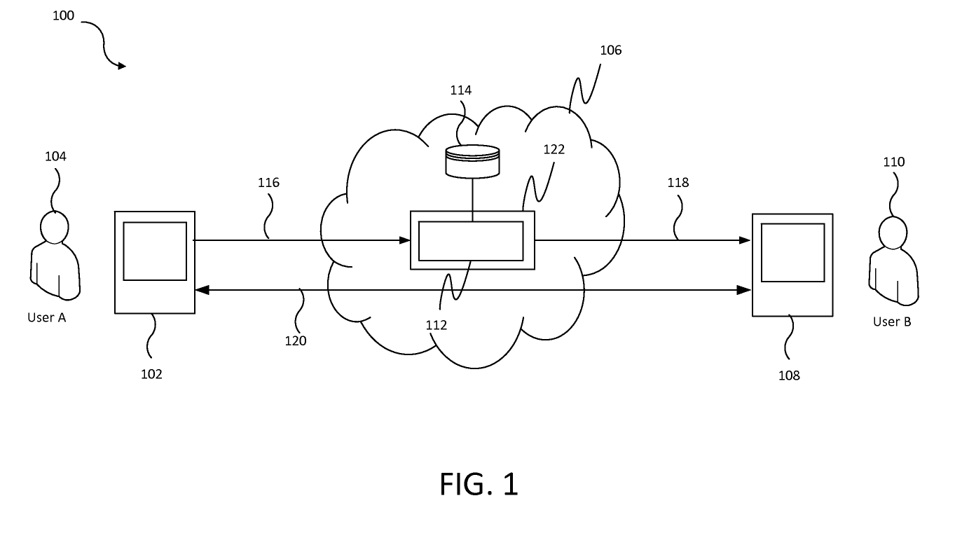

FIG. 1 shows a communication system 100 comprising a first user 104 (User A) who is associated with a first user terminal 102 and a second user 110 (User B) who is associated with a second user terminal 108. The user terminals 102 and 108 can communicate over the network 106 in the communication system 100, thereby allowing the users 104 and 110 to communicate with each other over the network 106. The user terminal 102 may be, for example, a mobile phone, a personal digital assistant (“PDA”), a personal computer (“PC”) (including, for example, Windows™, Mac OS™ and Linux™ PCs), a gaming device or other embedded device able to connect to the network 106. The user terminal 102 is arranged to receive information from and output information to the user 104 of the user terminal 102.

The network 106 may be any suitable network which has the ability to provide a communication channel between the first user terminal 102 and the second user terminal 108. The network 106 may be a circuit switched network (such as the PSTN or a cellular network), a packet switched network (such as the Internet or High data rate mobile network, such as a 3^{rd} generation (“3G”) mobile network) or a combination thereof.

Communication systems comprising a packet switched network enable a user of a device to conduct voice or video calls over the packet switched network. Such communication systems include voice or video over internet protocol (VoIP) systems. These systems are beneficial to the user as they are often of significantly lower cost than conventional fixed line or mobile cellular networks. This may particularly be the case for long-distance communication. To use a VoIP system, the user installs and executes client software on their device. The client software sets up the VoIP connections as well as providing other functions such as registration of the user. In addition to voice communication, the client may also set up connections for other communication media such as instant messaging (“IM”), SMS messaging, file transfer and voicemail.

Embodiments are described below with reference to a communication event conducted over a packet switched network, however, as will be described in more detail below, embodiments of the present disclosure are not limited to any particular type of network.

To conduct communication events over a packet switched network, the user terminal 102 executes a communication client, provided by a software provider associated with the communication system 100. The communication client is a software program executed on a local processor in the user terminal 102. The client performs the processing required at the user terminal 102 in order for the user device 102 to transmit and receive data over the communication system 100. As is known in the art, the client executed at the user terminal 102 may be authenticated to communicate over the communication system through the presentation of digital certificates (e.g. to prove that user 104 is a genuine subscriber of the communication system—described in more detail in WO 2005/009019).

The user device 108 may correspond to the user terminal 102. The user device 108 executes, on a local processor, a communication client which corresponds to the communication client executed at the user terminal 102. The client at the user device 108 performs the processing required to allow the user 110 to communicate over the network 106 in the same way that the client at the user terminal 102 performs the processing required to allow the user 104 to communicate over the network 106. The user terminals 102 and 108 are end points in the communication system. FIG. 1 shows only two users (104 and 110) and two user terminals (102 and 108) for clarity, but many more users and user devices may be included in the communication system 100, and may communicate over the communication system 100 using respective communication clients executed on the respective user devices, as is known in the art.

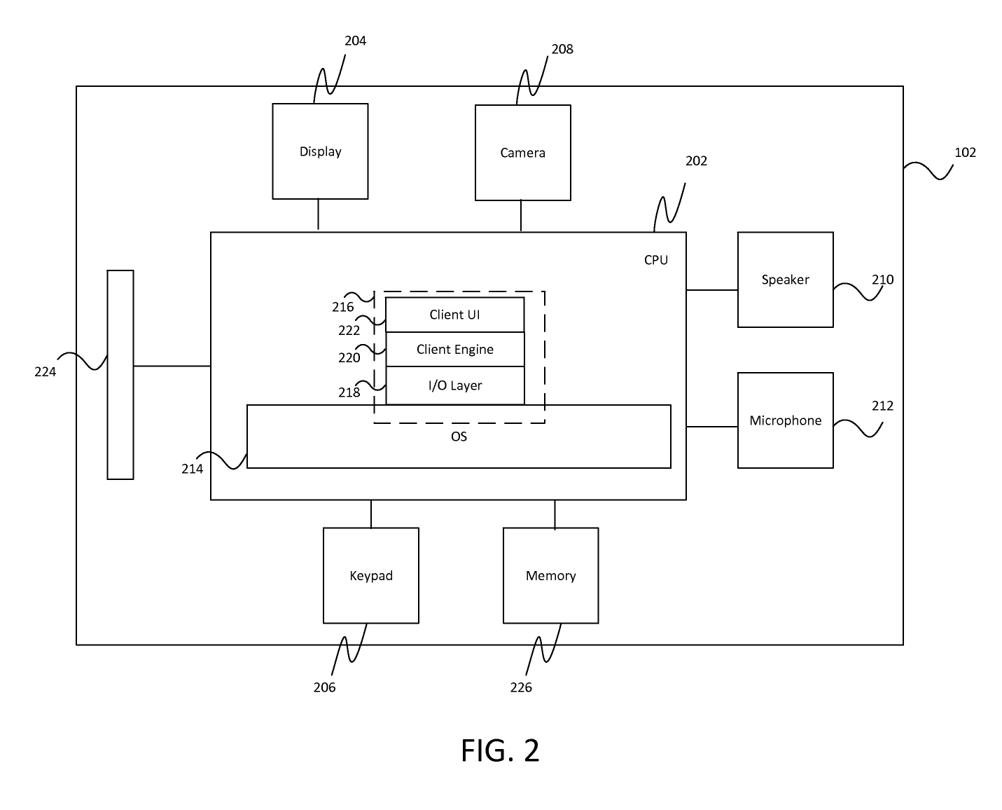

FIG. 2 illustrates a detailed view of the user terminal 102 on which is executed a communication client for communicating over the communication system 100. The user terminal 102 comprises a central processing unit (“CPU”) 202, to which is connected a display 204 such as a screen or touch screen, input devices such as a keypad 206 and a camera 208. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 102 as shown in FIG. 2. In alternative user terminals one or more of the display 204, the keypad 206, the camera 208, the output audio device 210 and the input audio device 212 may not be integrated into the user device 102 and may be connected to the CPU 202 via respective interfaces. One example of such an interface is a USB interface. The CPU 202 is connected to a network interface 224 such as a modem for communication with the network 106. The network interface 224 may be integrated into the user terminal 102 as shown in FIG. 2. In alternative user terminals the network interface 224 is not integrated into the user device 102. The user terminal 102 also comprises a memory 226 for storing data as is known in the art. The memory 226 may be a permanent memory, such as ROM. The memory 226 may alternatively be a temporary memory, such as RAM.

FIG. 2 also illustrates an operating system (“OS”) 214 executed on the CPU 202. Running on top of the OS 214 is a software stack 216 for the communication client application referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user terminals of the communication system 10. The client engine layer 220 handles the connection management functions of the VoIP system as discussed above, such as establishing calls or other connections by server-based or P2P address look-up and authentication. The client engine may also be responsible for other secondary functions not discussed herein. The client engine layer 220 also communicates with the client user interface layer 222. The client engine layer 220 may be arranged to control the client user interface layer 222 to present information to the user of the user terminal 200 via the user interface of the client which is displayed on the display 204 and to receive information from the user the user terminal 200 via the user interface.

Referring back to FIG. 1, the communication system 100 comprises an adjudicating module 112. FIG. 1 shows the adjudicating module 112 as being implemented on a network entity 122 (for example a server or other network node) in the network 106. However as will be described in further detail later herein, the adjudicating module 112 is not limited to being implemented on such an entity.

When user A 104 executes the communication client and registers with the software provider providing the communication client, user A is provided with a user account and is therefore associated with a unique identifier which identifies user A to other users of the communication system 100. The unique identifier may for example be a username which user A selected to identify themselves to other users of the communication system 100 during the registration process with the software provider providing the communication client, or an email address used in the registration process. Once user A has a user account, user A can access all of the functionality of the communication client by entering user credentials (i.e. the client username and an associated password set-up during the registration process). For example user A can place and receive calls to other users of the communication system 100.

It is possible for a third party, other than user A, to assert that they are user A and place a call to a user of the communication system 100. This situation may arise for example if the third party manages to obtain the user credentials for user A's account, or if the third party accesses a user terminal on which user A accessed and remained logged in to their account.

A user of the communication system 100 that knows user A (i.e. is a friend, business acquaintance, family member etc.) that receives a call from a calling party asserting user A's account identity would be able to determine that the calling party is in fact user A or not, by the way the calling party speaks (voice call) and/or the appearance of the calling party (video call).

This is not possible when the called party is not able to identify user A by recognising the speech and/or appearance of user A. It is particularly important for Banks, Financial Institutions, Utilities, and Government institutions etc. to be able to authenticate that a calling party is who they say they are before engaging in any transaction or other activity with the calling party.

The inventor has recognised that when certain users of the communication system 100 such as Banks and other Financial Institutions, Utilities, and Government institutions etc. receive a call from a calling party asserting a particular account identity, it is desirable for these called parties to be able to authenticate that a calling party is who they say they are in a process that does not suffer from the drawbacks of known authentication methods referred to above.

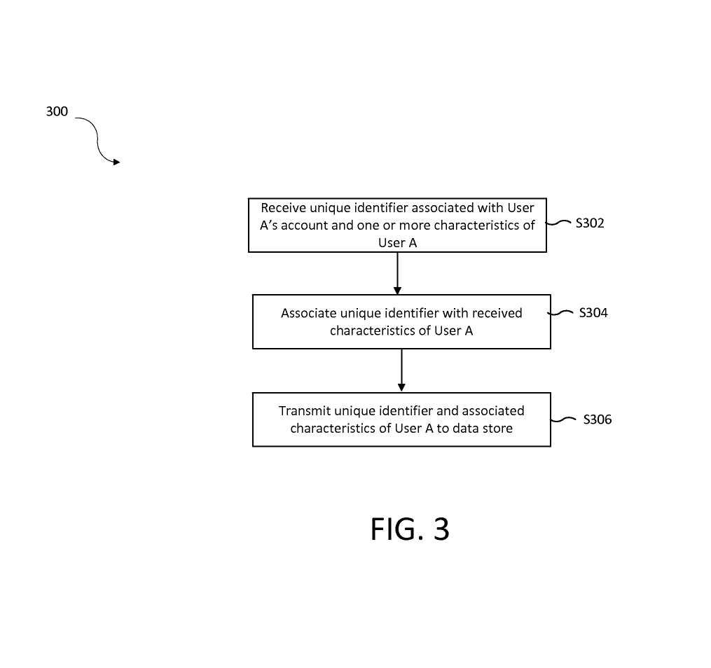

FIG. 3 is a process 300 implemented by the adjudicating module 112 to establish a record of characteristics of a particular user of the communication system 100 (i.e. user A) for use in an adjudicating process.

At step S302 the adjudicating module 112 receives the unique identifier associated with user A and one or more characteristics of user A from the communication client executed at user terminal 102 (this is represented in FIG. 1 as data flow 116).

The one or more characteristics of user A may include characteristics which can be directly associated with the unique identifier associated with user A. For example biometric information of user A captured using suitable means at user terminal 102 may be supplied to the adjudicating module 112.

The biometric information may take various forms. For example, the biometric information may include a fingerprint of user A obtained using touch screen 204 or a dedicated fingerprint scanner (not shown in FIG. 2). The biometric information may include an eye scan of user A captured by the camera 208. The biometric information may include a voiceprint obtained from user A using the microphone 212.

The biometric information may also include facial measurements of user A (i.e. a distance between the eyes, nose and mouth of user A) captured using the camera 208. It will be appreciated that the biometric information captured at the user terminal 102 and supplied to the adjudicating module 112 may include other forms well known to persons skilled in the art that are not mentioned herein.

The communication client executed at user terminal 102 may include functionality to process captured biometric information of user A such that the measurements are in a form to be sent to the adjudicating module 112. Alternatively, communication client executed at user terminal 102 may instruct dedicated biometric processing resources on the user terminal 102 to process captured biometric information and relay this to the communication client for transmittal to the adjudicating module 112.

The one or more characteristics of user A may include characteristics which can be indirectly associated with the unique identifier associated with user A. These ‘indirect’ characteristics are related to the activity of user A's account. For example, the ‘indirect’ characteristics may include the type of user terminal 102 used to access user A's account, an IP address of the user terminal 102 used to access user A's account, and the information pertaining to the time(s) of day user A's account is accessed.

Step S302 may be implemented as part of a specific ‘one time’ enrolment. For example, the one or more characteristics of user A may be captured and transmitted to the adjudicating module 112 when user A registers with the software provider providing the communication client. Alternatively or additionally step S302 may be triggered each time user A's account is actively used to communicate to a user of the communication system 100.

At step S304, the adjudicating module 112 associates the unique identifier associated with user A with the received characteristics of user A.

The adjudicating module 112 has access to a data store 114. The data store 114 is external to user terminal 102 and user terminal 108. For example, the data store 114 can be located in the communications network 106 (for example the data store 114 may be cloud based whereby data is stored over a plurality of computing devices in one or more physical locations), or on the premises of the called party i.e. Bank, Financial Institution, Utility, Government institution etc.

At step S306, the adjudicating module 112 transmits the unique identifier associated with user A and associated characteristics to the data store 114 for storage.

When step S302 is triggered each time user A's account is used to communicate to a user of the communication system 100, this advantageously enables the adjudicating module 112 to build, over time, a larger corpus of data (collection of characteristics) associated with the unique identifier associated with user A. As will be apparent from the adjudicating processes described later, a larger corpus of data enables a more reliable detection of anomalies and therefore provides a more accurate adjudication on the probability that the user initiating a communication event is validly correlated with the identity that this user asserts.

For example, by receiving biometric information of user A each time user A's account is used to communicate over the communication system 100, the adjudicating module 112 is able to build up a store of biometric information in the data store 114. It will be appreciated that captured biometric information may vary over time, as mere examples voiceprint information of user A captured at different times of day may vary, eye scan information may vary if user A is wearing glasses at the time of capture and facial measurements of user A may vary over time as user A ages. By collecting characteristics over time, a more complete collection of biometric information relating to user A can be stored in the data store 114. Similarly, by receiving the type of user terminal 102 used to access user A's account each time user A's account is used to communicate over the communication system 100, the adjudicating module 112 is able to determine and store information in the data store 114 on the type of user terminal which is most commonly used by user A. In yet another example, by receiving an IP address of the user terminal 102 used to access user A's account each time user A's account is used to communicate over the communication system 100, the adjudicating module 112 is able to determine and store information on the IP address of the user terminal which is most commonly used by user A.

Thus with increasing use of user A's account to communicate over the communication system 100, a more accurate collection of the characteristics which are associated with the unique identifier associated with user A can be obtained.

If at step S302 the adjudicating module 112 receives the unique identifier associated with user A and biometric information from the communication client executed at user terminal 102 that is outside predetermined tolerances of biometric information stored in the data store 114 associated with the unique identifier (associated with user A) the adjudicating module 112 can determine that the biometric information received at step S302 is an anomaly. For any anomalous biometric information the process 300 ends (does not proceed to step S304). This situation may occur for example if user A's child accesses user terminal 102 on which user A accessed and remained logged in to their account.

The accuracy of the one or more characteristics of user A stored in the data store 114 may be marked according to the date and/or time at which they were received at the adjudicating module 112 or the data store 114, wherein more recently received characteristics are marked as more accurate than other stored characteristics of user A.

Whilst process 300 has been described above with reference to user A, it will be appreciated that the process 300 is implemented for other users of the communication system 100 such that the data store 114 stores account identities and associated characteristics for a plurality of users of the communication system 100.

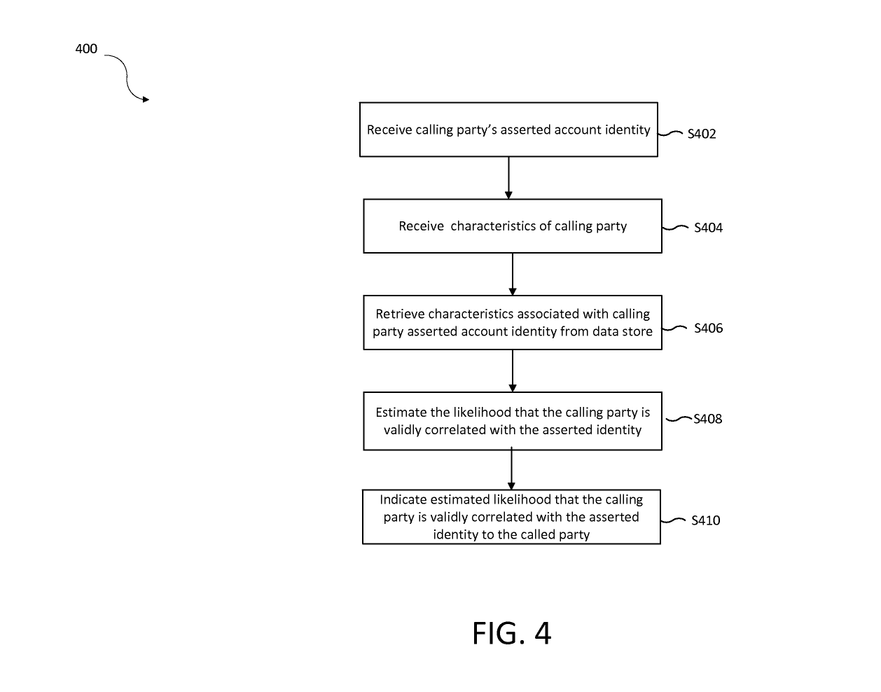

A first embodiment is now described with reference to an adjudicating process 400 shown in FIG. 4.

The process 400 is implemented during a real-time communication event between a calling party at a calling party device (e.g. user terminal 102) and a called party at a called party device (e.g. user terminal 108). The real-time communication event may include but is not limited to a voice call during which audio data can be exchanged between the user terminal 102 and user terminal 108, or a video call during which audio and video data can be exchanged between the user terminal 102 and user terminal 108, a file transfer, and an Instant Messaging (IM) conversation. The media data transmitted between user terminal 102 and user terminal 108 during a real-time communication event is represented in FIG. 1 as data flow 120.

The term “calling party” is used to refer to the user initiating the communication event, and the term “called party” is used to refer to the recipient of the communication event, these terms is not intended to limit to any particular type of communication event.

At step S402, the adjudicating module 112 receives an indication of an asserted identity of the calling party (the unique identifier associated with user A) used to establish the communication event with called party device from the communication client executed on user terminal 102 (this is represented in FIG. 1 as data flow 116).

It will be appreciated that the calling party may be user A or a user (not user A) posing as User A.

At step S404, the adjudicating module 112 receives one or more characteristics of the calling party. The one or more characteristics of the calling party may be received from the communication client executed on calling party device. For example, the adjudicating module 112 may receive from the communication client executed on the calling party device one or more of: biometric information of the calling party, an IP address of the terminal used by the calling party to access user A's account from the communication client executed on user terminal 102, the type of terminal used by the calling party to access user A's account from the communication client executed on user terminal 102, and the time of day that the user terminal 102 established the call with user terminal 108.

As will be appreciated following steps S402 and S404, the process 300 is performed by the adjudicating module 112.

At step S406, the adjudicating module 112 uses the indication of the asserted identity of the calling party (received at step S402) to query the data store 114 and retrieve one or more characteristics associated with the unique identifier (associated with user A) which have been stored at the data store 114 using the process 300 described above.

At step S408, the adjudicating module 112 compares the characteristics of the calling party received at step S404 and the characteristics associated with the unique identifier (associated with user A) retrieved from the data store 114 at step S406 to estimate the likelihood that the first user is validly correlated with the asserted identity. The adjudicating module 112 executes an algorithm to make an algorithmic assessment on the level of correlation between the characteristics of the calling party detected at step S404 and the characteristics associated with the unique identifier (associated with user A) retrieved from the data store 114 at step S406. The algorithm provides a statistical output (i.e. probability) which gives an estimation on the likelihood that the calling party is validly correlated with the asserted identity. In providing the statistical output the algorithm may take into account how recent the characteristics associated with the unique identifier (associated with user A) retrieved from the data store 114 are. Algorithms for performing this algorithmic assessment are well known to persons skilled in the art and are therefore not discussed in any further detail herein.

At step S410, the adjudicating module 112 transmits an indication of the estimated likelihood that the calling party is validly correlated with the asserted identity to the user terminal 108 (this is represented in FIG. 1 as data flow 118).

This indication may include the raw statistical output of the algorithm, such that the adjudicating module 112 transmits a probability that the calling party is validly correlated with the identity that the calling party asserts, to the called party. Alternatively, this indication may include an indication that the calling party is or isn't validly correlated with the identity that the calling party asserts (i.e. the indication is expressed in absolute terms). For example, if the adjudicating module 112 determines that the statistical output provided by the algorithm exceeds a predetermined threshold then the adjudicating module 112 may transmit an indication that the calling party is validly correlated with the identity that the calling party asserts, otherwise the adjudicating module 112 may transmit an indication that the calling party isn't validly correlated with the identity that the calling party asserts.

On receiving the indication of the estimated likelihood that the calling party is validly correlated with the asserted identity, the communication client executed at user terminal 108 may display the indication to the called party (user B) using the user interface of the communication client executed on the called party device displayed on the display 204.

Information pertaining to how the indication of the estimated likelihood that the calling party is validly correlated with the asserted identity was derived may be sent together with the indication of the estimated likelihood to the called party device. For example, information pertaining to the particular algorithm used by the adjudicating module 112 to provide the statistical output (i.e. probability) which gives the estimation on the likelihood that the calling party is validly correlated with the asserted identity, may be sent together with the indication of the estimated likelihood to the called party device.

It will be appreciated from the above described embodiment, that should user A access his own account and call a financial institution (e.g. a bank), user A is not prompted to enter pin numbers, or recall facts (such as mother's maiden name, first car etc.), but rather the financial institution is provided with an indication as to the high likelihood that the calling party (user A) is validly correlated to the identity that the calling party asserts during the communication event. Thus, the calling party (user A) is identified to the financial institution with an appropriate degree of trust which enables transactions to be concluded between user A and the financial institution without the inconvenience of passwords, answers to security questions etc.

The characteristics of the calling party received at step S404 and the characteristics associated with the unique identifier (associated with user A) retrieved from the data store 114 at step S406 may also be sent together with the indication of the estimated likelihood that the calling party is validly correlated with the asserted identity, to the called party device (user terminal 108). Adjudicating functionality at the called party device is then able to use this information to make its own independent estimation on the likelihood that the calling party is validly correlated with the asserted identity. For example, the called party device may execute its own algorithm to provide a statistical output (i.e. probability) which gives an estimation on the likelihood that the calling party is validly correlated with the asserted identity.

The communication client executed on the calling party device may transmit the indication of an asserted identity of the calling party (the unique identifier associated with user A) used to establish the communication event, and the one or more characteristics of the calling party, to the adjudicating module 112 at predetermined intervals from establishment of the communication event.

Additionally or alternatively, in response to a challenge (i.e. security question) communicated from the called party to the calling party during the communication event, the communication client executed on the calling party device may determine the indication of an asserted identity of the calling party (the unique identifier associated with user A) used to establish the communication event, and one or more characteristics of the calling party, and transmit these to the adjudicating module 112

This continual monitoring of characteristics of the calling party during the communication event ensures that the same user remains present for the duration of the communication event.

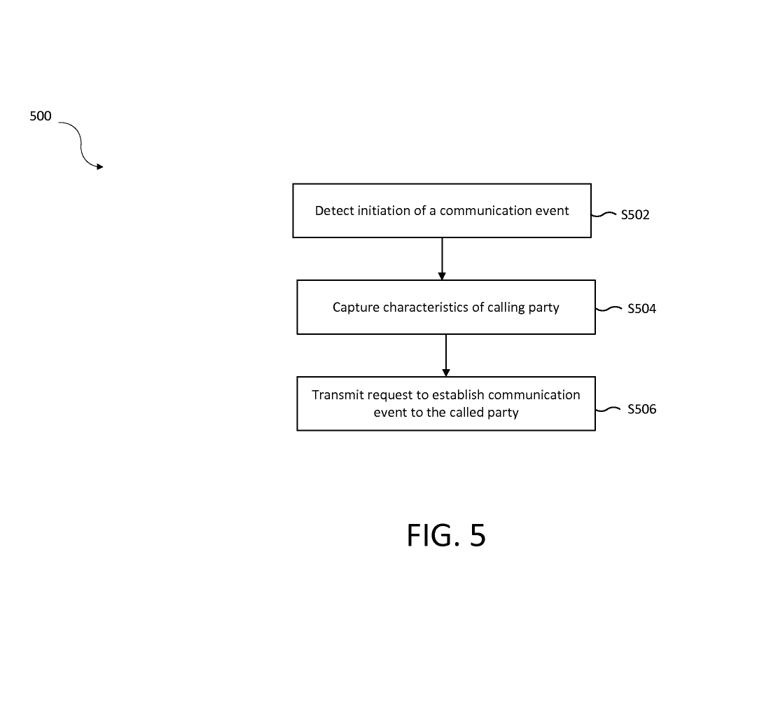

A second embodiment is now described with reference to a communication event establishment process 500 shown in FIG. 5.

At step S502, initiation of a communication event to a called party by a calling party is detected at the calling party device. For example, the communication client executed on the calling party device may detect initiation of a communication event by detecting one or more user selections made by the calling party via the client user interface displayed on the display 204 of the calling party device.

At step S504, one or more characteristics of the calling party are captured at the calling party device. For example, the communication client executed on the calling party device may prompt the calling party using an appropriate output device (for example an audible prompt using speaker 210 or a visual prompt using display 204) such that biometric information may be captured by the communication client via an appropriate input device (e.g. display 204, dedicated fingerprint scanner, camera 208, or microphone 212). Other characteristics of the calling party (such as device type information of the calling party device, the IP address of the calling party device, and time of day information) can be captured automatically by the communication client executed on the calling party device.

At step S506, a request to establish a communication event is transmitted to the called party, the transmitted request includes an indication of an asserted identity of the calling party and information relating to the captured one or more characteristics.

In a first implementation, step S506 is implemented by the communication client executed on the calling party device. That is, the communication client executed on the calling party device transmits the request to establish a communication event over the communication network 106 to the communication client executed on the called party device. In this example, the transmitted request includes an indication of an asserted identity of the calling party (the unique identifier associated with user A) and the captured one or more characteristics themselves. The communication client executed on the called party device knows the unique identifier associated with user A following user A's user credentials being entered in order to access the communication system 100.

Thus in one aspect of the present disclosure there is provided a method of: detecting at a first user device associated with a second user initiation by the first user of a communication event to a second user associated with a second user device; in response to said detection, capturing biometric information of the first user at the first user device; and transmitting a request to establish a communication event to the second user, the transmitted request including an indication of an asserted identity of the first user and the captured biometric information of said first user.

In this first implementation, an enhanced request to establish a communication event is transmitted to the called party device without involvement from the adjudicating module 112 in that the request comprises additional data (the one or more captured characteristics). This additional data can be used by the called party to make an assessment as to the likelihood that the calling party is validly correlated with the asserted identity.

In a second implementation, a request to establish a communication event is transmitted to the adjudicating module 112 from the communication client executed on the calling party device.

The request to establish a communication event transmitted from the communication client executed on the calling party device to the adjudicating module 112 comprises an indication of an asserted identity of the calling party (the unique identifier associated with user A). Referring back to the adjudicating process 400, it can therefore be seen that from receiving the request to establish a communication event, at step S402, the adjudicating module 112 receives an asserted identity of the calling party (the unique identifier associated with user A).

At step S404, the adjudicating module 112 receives the captured one or more characteristics of the calling party from the communication client executed on user terminal 102. The captured one or more characteristics of the calling party may be received in the request to establish a communication event received from the communication client executed on user terminal 102. Alternatively, the one or more characteristics of the calling party may be received from the communication client executed on user terminal 102 in a separate message to the request to establish a communication event.

The adjudicating module 112 then performs steps S406 and S408 as described above.

At step S410, the adjudicating module 112 transmits an indication of the estimated likelihood to the called party such that the called party can make an assessment as to the likelihood that the calling party is validly correlated with the asserted identity. In the above described implementation, this is realised by the adjudicating module 112 transmitting the request to establish a communication event to the communication client executed on the called party device, the transmitted request (transmitted from the adjudicating module 112) includes the indication of the estimated likelihood that the calling party is validly correlated with the asserted identity.

The form that the indication of the estimated likelihood may take is described above with reference to the first embodiment therefore for clarity is not repeated herein.

The request to establish a communication event transmitted from the adjudicating module 122 to the communication client executed on the called party device may additionally comprise information pertaining to how the indication of the estimated likelihood that the calling party is validly correlated with the asserted identity was derived. For example, information pertaining to the particular algorithm used by the adjudicating module 112 to provide the statistical output (i.e. probability) which gives the estimation on the likelihood that the calling party is validly correlated with the asserted identity, may be supplied in the request to establish a communication event transmitted from the adjudicating module 112 to the communication client executed on the called party device.

Furthermore, the one or more captured characteristics of the calling party received by the adjudicating module 112 at step S404 and the characteristics associated with the unique identifier (associated with user A) retrieved from the data store 114 at step S406 may also be sent together with the indication of the estimated likelihood that the calling party is validly correlated with the asserted identity, to the called party device (user terminal 108). Adjudicating functionality at the calling party device is then able to use this information to make its own independent estimation on the likelihood that the calling party is validly correlated with the asserted identity.

The communication client executed at the calling party device may display the request to establish a communication event and the indication of the estimated likelihood that the calling party is validly correlated with the asserted identity to the called party (user B) using the user interface of the communication client executed at user terminal 108 displayed on the display 204.

Thus it will be appreciated that this second implementation provides an enhanced request to establish a communication event in that the request comprises additional data that can be used by the called party to make an assessment as to the likelihood that the calling party is validly correlated with the asserted identity.

Should user A access his own account and call a financial institution (e.g. a bank), before even accepting the call, the financial institution is provided with an immediate indication as to the high likelihood that the calling party (user A) is validly correlated to the identity that the calling party asserts. Thus, user A is identified to the financial institution with an appropriate degree of trust which enables transactions to be concluded between user A and the financial institution without the inconvenience of passwords, answers to security questions etc.

In both of the described implementations of the second embodiment, should the called party accept the request to establish a communication event, the process 400 may be performed during the communication event to ensure that the calling party still validly correlates with the identity that the calling party asserts (e.g. to ensure that the same user remains present on the call).

The characteristics referred to above may be considered identity reputation “vectors” in the sense that they have a quantitative value, but also the adjudicating module 112 may enhance the characteristics by segmenting them according to the recipient of the communication event. This adds a second dimension to the characteristics stored in the data store 114. That is, the data store 114 stores “inclusive” characteristics of all communication events initiated by user A regardless of recipient (the total corpus of data), and also stores “exclusive” characteristics (a subset of the total corpus of data) of communication events initiated by user A to a specific user, or group of users of the communication system 100. In the process 400, based on the recipient of the call, the adjudicating module 112 may retrieve all the inclusive characteristics associated with the calling party stored in the data store 114 at step S406. Alternatively, the adjudicating module 112 may retrieve all exclusive characteristics of user A obtained from previous communication events to the recipient of the present communication event (or obtained from previous communication events to a group of users comprising the recipient of the present communication event) the calling party stored in the data store 114 at step S406. Thus, it will be appreciated that the estimated likelihood that the calling party is validly correlated with the asserted identity output by the algorithm at step S408, will depend on whether inclusive or exclusive characteristics of user A were retrieved from the data store at step S406. For example, the algorithm may provide a higher confidence level at step S408 if exclusive characteristics of user A were retrieved from the data store at step S406.

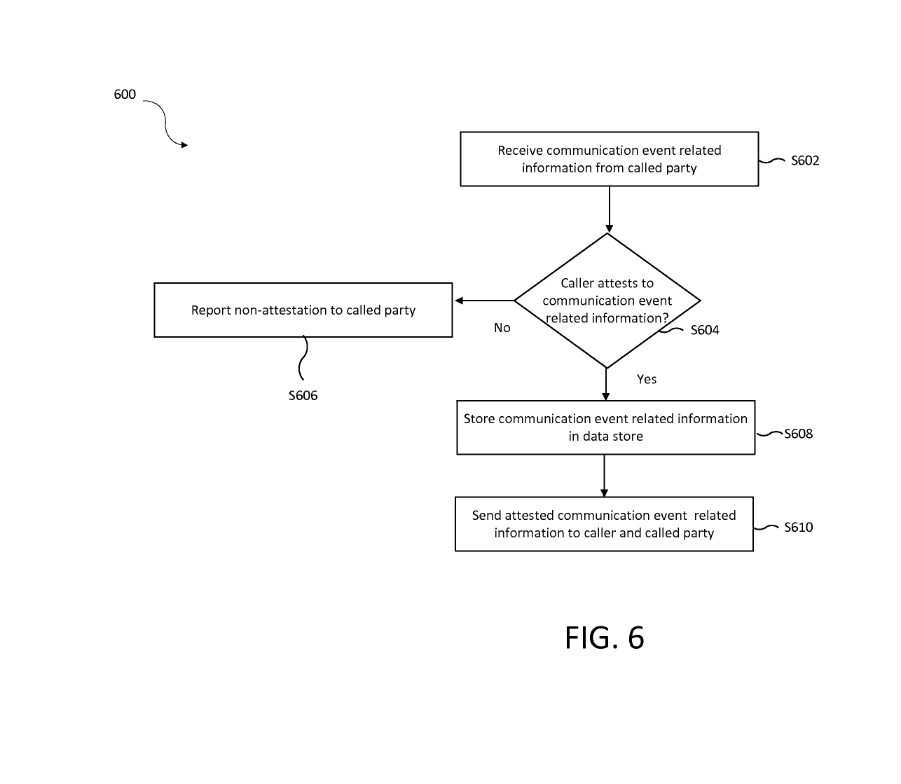

A “snapshot” (i.e. a summary) of a communication event can be stored by the adjudicating module 112 in the data store 114 and copied to parties of the communication event to aid in non-repudiation. This will now be described with reference to the non-repudiation process 600 shown in FIG. 6.

At step S602, the adjudicating module 112 receives communication event related information from the communication client executed on the called party device. This communication event related information may include an image, a document, a video clip (for example of a pertinent part of the conversation, an audio recording or other ‘media’ or ‘data’. The communication event related information is captured by the communication client executed on the called party device during the real-time communication event between the calling party device and the called party device, and is intended to provide a summary of the whole or part of the communication event between the calling party and the called party. For example the communication event related information may relate to a transaction made during the communication event.

At step S604, the adjudicating module 112 transmits the communication event related information to the communication client executed on the calling party device. The communication client executed on the calling party device may output the communication event related information to the calling party using suitable output means (e.g. the client user interface displayed on display 204) and requests that the calling party attests to the communication event related information provided by the called party device.

If the calling party does not attest the call related information transmitted to the calling party device, the adjudicating module 112 reports the non-attestation of the communication event related information to the called party device at step S606. The communication client executed on the called party device may report the non-attestation of the call related information to the called party using suitable output means (e.g. the client user interface displayed on display 204) of the called party device.

If the calling party does attest the communication event related information transmitted to the calling party device, the adjudicating module 112 stores the communication event related information in the data store 114. At step S610, the adjudicating module 112 transmits the attested communication event related information to the calling party device and to the called party device. This aids in non-repudiation of the of the whole or part of the communication event between the calling party and the called party

The adjudicating module 112 may be configured such that communication event related information is only stored in the data store 114 if both the calling party and the called party consent to the adjudicating module 112 storing data associated with the communication event between these parties.

Whilst FIG. 6 has been described with reference to the adjudicating module 112 receiving communication event related information from the communication client executed on the called party device and the calling party attesting to the communication event related information. In another embodiment, the adjudicating module 112 may receive communication event related information from the communication client executed on the calling party device at step S602 and the called party may have to attest to the call related information before the call related information is stored at step S608.

FIG. 1 shows the adjudicating module 112 as being implemented on a network entity 122 in the network 106, however embodiments of the present disclosure are not limited to this particular network architecture. The adjudicating module 112 may be implemented on the calling party device, for example the adjudicating module 112 may implemented on CPU 202 or a separate processing means of the calling party device. The adjudicating module 112 may also be implemented on the called party device, for example the adjudicating module 112 may implemented on CPU 202 or a separate processing means of the called party device.

In the communication system 100, real-time communication event data transmitted from user terminal 102 may be supplied to a media processor (not shown in FIG. 1) in the communication network 106 before being transmitted to the user terminal 108. The media processor handles real-time communication event data during a communication event between user terminal 102 and user terminal 108. The media processor is able to determine the unique identifier of the calling party used to establish the communication event with user terminal 108 and one or more characteristics of user A's account identity from the real-time communication event data.

In the first embodiment described above, with reference to step S302 the adjudicating module 112 may receive the unique identifier associated with user A and/or one or more characteristics of user A from the media processor rather than the communication client executed on user terminal 102. Similarly, with reference to step S402, the adjudicating module 112 may receive an indication of an asserted identity of the calling party (the unique identifier associated with user A) used to establish the communication event with user terminal 108 from the media processor rather than the communication client executed on user terminal 102.

Alternatively or additionally in the first embodiment described above, some or all of the one or more characteristics of the calling party received at the adjudicating module 112 at step S404 may be received from the media processor rather than the communication client executed on user terminal 102. As a mere example, the media processor may capture biometric information from the real-time communication event data. The biometric information captured from the real-time communication event data may comprise for example: eye scan information of user A captured from real-time video data, voiceprint information of user A captured from real-time video data, and facial measurements of user A (i.e. a distance between eyes, nose and mouth) captured from real-time video data In this embodiment, the media processor processes the captured biometric information of user A such that the measurements are in a form to be sent to the adjudicating module 112, and then supplies the captured biometric information to the adjudicating module 112.

To increase security, the onboarding process 300 could be repeated (e.g. in a physical location) under the control of the called party (e.g. by user A visiting a bank office for a one-time process or similar). Characteristics of user A obtained in this manner may be marked as such and in the adjudicating process 400 these characteristics may be regarded as having a higher degree of accuracy and reliability than characteristics of user A obtained in other manners described herein.

The steps shown separately in FIG. 3 to 6 may or may not be implemented as separate steps.

Generally, any of the functions described herein can be implemented using software, firmware, hardware (e.g., fixed logic circuitry), or a combination of these implementations. The terms “module,” “functionality,” “component”, “application”. and “logic” as used herein generally represent software, firmware, hardware, or a combination thereof. In the case of a software implementation, the module, functionality, component, application, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of indicating a reputation of a first user associated with a first user device to a second user associated with a second user device, the method comprising:
detecting at the first user device initiation by the first user of a communication event to the second user;
in response to said detection, capturing one or more characteristics of said first user at the first user device; and
transmitting a request to establish a communication event to the second user, the transmitted request including an indication of an asserted identity of the first user and information relating to the captured one or more characteristics of said first user such that the second user can make an assessment as to the likelihood that the first user is validly correlated with the asserted identity.

2. The method of claim 1, wherein a communication client executed on the first user device performs said method, wherein the communication client transmits the request to establish a communication event to the second user device over a communications network, the transmitted request comprising the captured one or more characteristics of said first user.

3. The method of claim 1, wherein a communication client executed on the first user device performs said detecting and said capturing, said communication client transmitting the indication of an asserted identity of the first user and the information relating to the captured one or more characteristics of said first user to an adjudicating module, wherein the method further comprising the adjudicating module estimating the likelihood that the first user is validly correlated with the asserted identity and transmitting the request to establish a communication event to the second user, the transmitted request comprising an indication of the estimated likelihood.

4. The method of claim 3, wherein the adjudicating module is configured to store one or more characteristics in association with an indication of an identity of at least one known user in a data store, and estimating the likelihood that the first user is validly correlated with the asserted identity comprises:
querying the data store to determine that the asserted identity corresponds with an identity of one of said at least one known user;
retrieving one or more characteristics associated with the asserted identity of the first user from said data store;
comparing the one or more characteristics retrieved from the data store with the received one or more characteristics of said first user to estimate the likelihood that the first user is validly correlated with the asserted identity.

5. The method according to claim 4, wherein the one or more characteristics stored in association with the indication of an identity of a known user in the data store are received from a communication client executed on a device associated with the known user during a registration process with the provider providing the communication client.

6. The method according to claim 4, wherein one or more characteristics stored in association with the indication of an identity of a known user in the data store are received from at least one of:
a communication client executed on a device associated with the known user, in response to at least one previous communication event being initiated by the known user; and
a media processor in said communications network, in response to the media processor handling communication event data of at least one previous communication event being initiated by the known user.

7. The method according to claim 4, wherein the one or more characteristics stored in association with the indication of an identity of a known user in the data store, and the retrieved one or more characteristics associated with the asserted identity of the first user comprise at least one of:
biometric information of the known user;
information of the type of user devices used by the known user to communicate over said communications network;
address information relating to the user devices used by the known user to communicate over said communications network;
information pertaining to the time of day at which the known user has communicated over said communications network.

8. The method according to claim 7, wherein the biometric information of the known user may comprise one or more of fingerprint information of the known user, eye scan information of the known user, a voiceprint of the known user, and facial measurements of the known user.

9. The method according to claim 1, wherein the captured one or more characteristics of said first user comprise at least one of:
biometric information of the first user;
device type information of the first user device;
address information relating to the first user device; and
information related to the time of day of said communication event.

10. The method according to claim 9, wherein the biometric information of the first user may comprise one or more of fingerprint information of the first user, eye scan information of the first user, a voiceprint of the first user, and facial measurements of the first user.

11. The method according to claim 4, wherein the comparing the one or more characteristics retrieved from the data store with the received one or more characteristics of said first user determines a probability that the calling party is validly correlated with the identity that the calling party asserts.

12. The method according to claim 11, wherein the transmitted request comprises the probability that the calling party is validly correlated with the identity that the calling party asserts.

13. The method according to claim 12, wherein the transmitted request additionally comprises information pertaining to how said probability was derived.

14. The method according to claim 11, the method comprising the adjudicating module comparing the determined probability to a predetermined threshold and if the determined probability exceeds said threshold the transmitted request comprises an indication that the first user is validly correlated with the asserted identity, otherwise the transmitted request comprises an indication that the first user is not validly correlated with the asserted identity.

15. The method according to claim 4, the method further comprising the adjudicating module transmitting the received one or more characteristics of said first user and the one or more characteristics associated with the asserted identity of the first user retrieved from said data store, to the second user.

16. The method according to claim 1, wherein the indication of an asserted identity comprises a username or an email address associated with the first user.

17. The method according to claim 1, wherein the communication event is one of: a voice call, a video call, a file transfer, and an Instant Messaging (IM) conversation.

18. The method according to claim 2, wherein the communication client executed on the first user device performs said detecting by detecting or more user selections made by the first user via a user interface displayed by the communication client executed on a display of the first user device.

19. A network entity, the network entity configured to indicate a reputation of a first user associated with a first user device to a second user associated with a second user device, the network entity comprising a processor configured to:
store one or more characteristics in association with an indication of an identity of at least one known user in a data store coupled to said network entity;
receive a request to establish a communication event to the second user from the first user device, the request comprising an indication of an asserted identity of the first user
receive one or more characteristics of said first user from the first user device;
query the data store to determine that the asserted identity corresponds with an identity of one of said at least one known user;
retrieve one or more characteristics associated with the asserted identity of the first user from said data store;
compare the one or more characteristics retrieved from the data store with the received one or more characteristics of said first user to estimate the likelihood that the first user is validly correlated with the asserted identity; and
transmit the request to establish a communication event to the second user device, the transmitted request comprising an indication of the estimated likelihood such that the second user can make an assessment as to the likelihood that the first user is validly correlated with the asserted identity.

20. A user device configured to indicate a reputation of a first user to a second user during a communication event between said first user and said second user over a communications network, the user device being associated with said first user or said second user, and comprising a processor configured to:
store one or more characteristics in association with an indication of an identity of at least one known user in a data store external to said user device;
receive a request to establish a communication event to the second user and one or more characteristics of said first user from the first user, the request comprising an indication of an asserted identity of the first user;
query the data store to determine that the asserted identity corresponds with an identity of one of said at least one known user;
retrieve one or more characteristics associated with the asserted identity of the first user from said data store;
compare the one or more characteristics retrieved from the data store with the received one or more characteristics of said first user to estimate the likelihood that the first user is validly correlated with the asserted identity; and
transmit the request to establish a communication event to the second user, the transmitted request comprising an indication of the estimated likelihood such that the second user can make an assessment as to the likelihood that the first user is validly correlated with the asserted identity.
